(19) United States
(12) Patent Application Publication
(10) Pub. No.: US 2016/0243744 A1
(43) Pub. Date: Aug. 25, 2016

(54) EXTRUSION SYSTEM, FOR MAKING MOLDED PLASTIC PARTS

(71) Applicant: GNEUSS KUNSTSTOFFTECHNIK GmbH, Bad Oeynhausen (DE)

(72) Inventors: Detlef GNEUSS, Bad Oeynhausen (DE); Daniel GNEUSS, Charlotte, NC (US)

(21) Appl. No.: 15/144,536

(22) Filed: May 2, 2016

(30) Foreign Application Priority Data
Apr. 13, 2016 (DE) 202016101935

(51) Int. Cl. B29C 47/08

(52) U.S. Cl. CPC B29C 47/0811; B29L 2007/007

(57) ABSTRACT

An extrusion system for producing molded parts from plastics has an extruder with an input part for receiving, melting and working plastic material, a multi-screw extruder connected to the extruder input part, and an extruder output for outputting the melt. A material supply is connected to the input part, for solid, liquid and/or gaseous raw materials or additives, and a motor drives the extruder. A vacuum system, is connected at least to the multi-screw extruder, and a measurement device and a downstream extrusion die are provided on the extruder output part. A controller receives measurement signals from the measurement device and controls the individual components of the extrusion system.

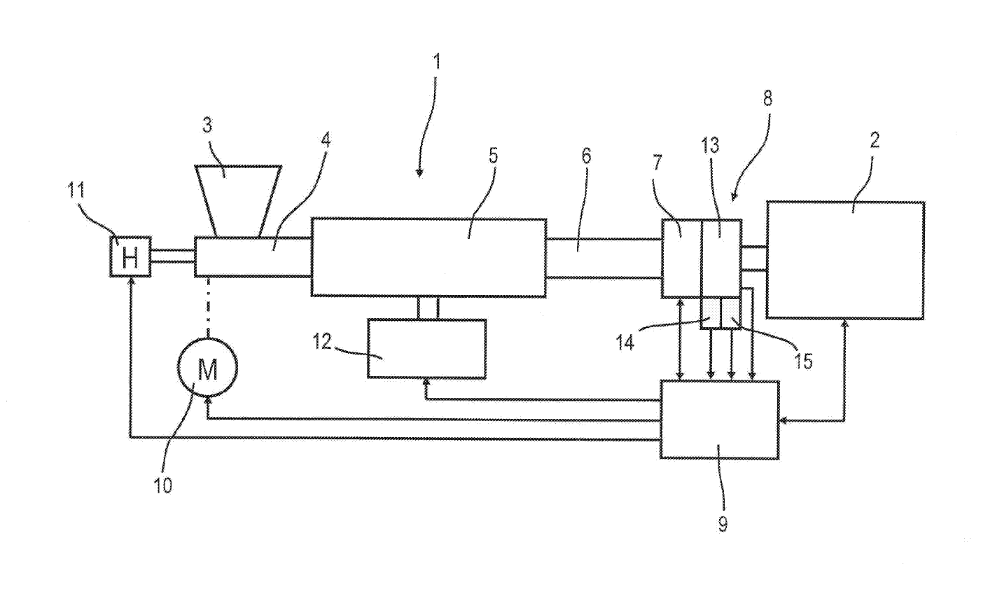

### FIELD OF THE INVENTION

The present invention relates to an extrusion system. More particularly this invention concerns such a system for making molded plastic parts.

### BACKGROUND OF THE INVENTION

A typical extrusion system for producing molded items from plastics, has:
an extruder for obtaining plastic melts, which has an extruder input part for receiving, melting and working plastic blanks,
a multi-screw extruder part, which is connected to the extruder input part, and an extruder output part for outputting the melt;
a material supply, which is assigned to the extruder input part, for solid, liquid and/or gaseous raw materials or additives;
a motor for driving the extruder in a rotary manner;
a heater; and
a vacuum system.

Such an extruder can be used to process any solid, liquid and/or gaseous raw materials or additives, even contaminated ones, such as production wastes, for example, punch wastes, cut edges, fibrous wastes and recycling PET, e.g. PET bottle flakes, to form high-quality packaging films or strips, granules and fibers, which are even suitable for food use, from polyester.

An extruder for obtaining plastic melts for use in an extrusion system of the type mentioned above in order to produce molded parts from plastics is known from EP 1 434 680 B1, and a development thereof is known from DE 10 2014 203 654 B4. The extruder consists essentially of a central screw and satellite screws, which lie partially inside and are set in rotation in the opposite direction to the rotation of the central screw in the multi-screw extruder part by means of a gearing system. A known extrusion system of this type having a multi-screw extruder part is also referred to as a multi-rotation system.

Depending on the field of use and the required process task, it is necessary to match the setting parameters of the individual components of the extrusion system to each other. This is very complex in the prior art, because the components must be harmonized with each other. For instance, the vacuum, the fill level, the temperature and the dwell time on the extruder must be defined. The installation must also be set to remove undesirable substances from the melt, according to the desired properties in the melt.

### OBJECT OF THE INVENTION

The invention proceeds from the object of designing an extrusion system for producing molded parts from plastics of the above-mentioned type in such a manner that the installation can be used for a large and varied range of uses and has excellent properties for homogenizing and for supplying gas to and removing gas from melts.

### SUMMARY OF THE INVENTION

The object is achieved according to the invention for an extrusion system of the above-mentioned type by the features given in claim 1. Advantageous configurations are specified in the dependent claims.

The object is achieved according to the invention in that a measurement device and a downstream extrusion die are arranged on the extruder output part, that an installation control unit is provided to receive measurement signals of the measurement device and to control the individual components of the extrusion system and is configured such that dose and/or fill level and/or dwell time and/or extruder rotation speed and/or vacuum can be regulated and set by means of the material supply and/or the motor and/or the vacuum system in such a manner that the respective molded parts to be created have optimal properties in respect of the demands made of them.

This extrusion system according to the invention provides a universally usable device for conditioning raw materials, in particular recycled material, for downstream extrusion dies, in which the setting parameters of the individual components such as vacuum, fill level, temperature and dwell time of the extrusion system can be harmonized with each other depending on the field of use and required process task, so that these properties can be used advantageously in particular in the production of end products in addition to the provision of a melt for raw material production. The extrusion system according to the invention having the multi-rotation system opens up new possibilities for efficient degassing and extrusion of plastic melts. Additionally or alternatively, gases or fillers can be introduced homogeneously into the melt.

It has proven advantageous if the measurement device has an online viscometer for online measurement of the melt viscosity.

It has proven effective if the measurement device has melt pressure transducers for controlling the vacuum in the extruder by means of the installation control unit, in order to set the melt viscosity.

It is notable that the installation control unit is configured such that property measured values derived from the downstream extrusion dies are determined in order to control the individual components of the extrusion system. To this end, the installation control unit can be supplied with the operating parameters of the downstream extrusion dies as measured values for controlling the individual components of the extrusion system; the operating parameters of the downstream extrusion dies that are supplied to the installation control unit can be the load received by stretching mechanisms for elongating film webs in the longitudinal direction thereof and/or the motor load of drive assemblies.

It is advantageous if the measurement device is configured such that the yellow value of the melt is detected online and any addition of solvent necessary is controlled by means of the installation control unit.

Advantageously, the vacuum system, which is assigned to the extruder in order to remove gases or substances from the melt, can apply a required pressure to the melt, controlled by the installation control unit on the basis of the measured values of the measurement device.

It is notable that the installation control unit is configured such that it calculates the parameters to be set at the extruder, such as pressures, fill level, dwell time and temperature, according to the geometric parameters of the specific surface from already known settings of known installations.

It is recommended to configure the installation control unit such that in particular the properties of the melt, of the extruded molded body and/or of the end product that are measured during operation are regulated by controlling the vacuum.

It is advantageous if the extruder input part and/or the extruder output part have a central screw or a double screw.

It has proven effective that the multi-screw extruder part has interior satellite screws, which are set in rotation in the opposite direction to the rotation of the central screws by a gearing mechanism.

It is notable that the extruder can be charged with polymer from a polymerization installation or other extrusion systems, since, for example, the thermal energy already present in the material can be used better thereby, the time between the stages can be reduced and/or the process can be made particularly cost-effective and efficient by a continuous process.

It is advantageous that the molded parts consist of polymer or polymer mixtures, to which other constituents, additives or fillers can be added to produce the desired product properties, and therefore in particular the production of foamed molded parts is also possible, depending on the assemblies and material supplies used.

Further assemblies such as plasticizing extruders, melt extruders, melt pumps, static and dynamic mixers, mixing blocks, screen changers, melt valves, melt coolers, secondary extruders, gas injectors, liquid metering systems, continuously operating reactors, cutter compactors and/or agglomerators, can advantageously be assigned to the extruder.

It is advisable to arrange a melt filter on the extruder output part of an extrusion system according to the invention.

It is notable that the plastic blanks can be plastic granules, PET bottle flakes or fibrous materials.

It has been found advantageous if the downstream extrusion die creates molded parts from the group of yarns such as filaments, staple fibers, POY (partially oriented yarn) fibers or filaments, FDY (fully drawn yarn) fibers or filaments, fibers and/or BCF (bulked continuous filament) as well as boards, axially or biaxially drawn films, strips and/or ribbons, or granules, tubes, profiles, meshes, spunbonds, melt-blown nonwovens and/or injection-molded bodies.

### BRIEF DESCRIPTION OF THE DRAWING

The invention is explained in more detail below on the basis of an illustrated embodiment shown in the drawing. The FIGURE shows an extrusion system according to the invention.

### SPECIFIC DESCRIPTION OF THE INVENTION

The FIGURE shows an extrusion system for producing molded parts from plastics, having an extruder 1, at the output of which a downstream extrusion die 2 is arranged.

Solid, liquid and/or gaseous raw materials or additives, for example plastic blanks, can be added to an extruder input part 4 of the extruder 1 via a material supply 3. Following the melt flow further, the extruder 1 has a multi-screw extruder part 5 and an extruder output part 6, which is connected via a melt filter 7 and a measurement device 8 to the downstream extrusion die 2. The measurement signals of the measurement device 8 are supplied via interfaces and bus systems to an installation control unit 9, which evaluates them.

A shaft, driven by a motor 10, can pass through the extruder 1, which shaft can be in the form of a central screw in the extruder input part 4 and/or in the extruder output part 6.

The extruder 1 is provided with a heater 11, so that all the faces in contact with the melt can be brought to the temperature required for the respective melt. This specifically monitored temperature management of the melt can be achieved by providing the shaft that passes through the extruder 1 and is driven by the motor 10 with a bore for conveying the temperature control medium.

For degassing, the extruder 1 can be assigned a vacuum system 12, which sets the total pressure in the process unit, or the partial pressure of certain gaseous constituents by means of the installation control unit 9.

The measurement device 8 arranged at the output of the extruder 1 can consist of an online viscometer 13, melt temperature sensors 14 and/or melt pressure transducers 15, which transmit their measured values to the installation control unit 9.

The extruder input part 4 and the extruder output part 6 can each be provided in a known manner with a central screw or else with a double screw. The multi-screw extruder part 5 can have a plurality of conveyor or satellite screws that lie partially inside, as described for example in EP 1 434 680 B1 or DE 10 2014 203 654 B4.

In this extruder 1 according to the invention, the input material is conducted from the material supply 3 to a rotating screw drum of the extruder input part 4 and plasticized there. In the drum of the multi-screw extruder part 5 there are for example eight cylinder bores along the rotation axis, with conveyor or satellite screws set therein. The conveyor or satellite screws are driven by means of a ring gear so that they rotate on their rotating circular path in the opposite direction to the screw drum of the extruder input part 4. This overproportionally increases the surface exchange effect of the melt.

The downstream extrusion die 2 can be used to create molded parts of any kind. These can be for example granules, tubes, profiles, meshes, spunbonds, melt-blown nonwovens, films, boards, axially or biaxially drawn films, strips, ribbons, filaments, staple fibers, POY (partially oriented yarn) fibers/filaments, FDY (fully drawn yarn) fibers/filaments, fibers, BCF (bulked continuous filament) or injection-molded bodies.

The extruder 1 of the extrusion system for producing molded parts from plastics can also be assigned the following assemblies, arranged in a technically meaningful manner: plasticizing extruders (single- or multi-shaft system), melt extruders (single- or multi-shaft system), melt pumps, static and dynamic mixers, mixing blocks, melt filters, screen changers, melt valves, melt coolers, secondary extruders, gas injectors, liquid metering systems, continuously operating reactors, cutter compactors and/or agglomerators.

The molded parts produced with the extrusion system consist of polymer or polymer mixtures, depending on the assemblies and material supplies used. Other solid, liquid or gaseous constituents, additives or fillers can also be included to produce the desired product properties. In particular, foamed molded parts can also be produced.

By means of a plurality of interfaces and bus systems, as appropriate, the installation control unit 9 effects the actuation and regulation of the motor 10 to drive the extruder 1, the heater 11 for the whole extruder 1, the drive of the vacuum system 12 for setting the pressure, the pressure measurements of the whole installation by means of melt pressure transducers 15, the online viscometer 13, the melt filter 7, the metering and granulation through the material supply 3, and where appropriate the downstream extrusion die 2.

The vacuum system 12 can set the total pressure in the extruder 1 or the partial pressure of certain gaseous constituents by means of the installation control unit 9, depending on the use and the desired properties, within the ranges >100 bar or 1 to 100 bar overpressure or vacuum from 100 mbar to 1 bar, 10 to 100 mbar, 1 to 10 mbar, 0.1 to 1 mbar or <0.1 mbar. Here, a higher absolute pressure must be set for adding gas, and a lower absolute pressure must be set for degassing. Pressures in the high-vacuum range can be provided for specific applications.

In this case, not only the generation of the vacuum itself, but also the deposition of foreign substances out of the degassed vapors is important. A particular application is the removal of substances from the melt, for example solvents or water, which were added previously either as carrier material for additives or fillers (e.g. in suspension) or to achieve certain melt properties, but which are harmful or disruptive in subsequent processing during extrusion or in the end product, or which must be recovered for cost reasons. The solvents or water can be removed efficiently and cost-effectively after the desired properties have been set in the melt, while additives and fillers remain in the polymer melt.

In addition to the pressure setting, fill level, dwell time and temperature determine the process properties in the extruder 1. Therefore, these process-defining parameters can also be regulated by the installation control unit 9. To this end, the production-relevant measured values of the measurement device 8 arranged at the output of the extruder 1, of the online viscometer 13, of the melt temperature sensors 14 and/or of the melt pressure transducers 15 are transmitted to the installation control unit 9. The unit controls the vacuum via the vacuum system 12, the fill level by metering through the material supply 3, and the dwell time by means of the extruder rotation speed via the motor 10, so that the most advantageous conditions possible are produced for the end product or for carrying out a subsequent extrusion production step or for further treatment of the extruded molded body, by removing disruptive constituents.

To set the vacuum, the fill level and/or the dwell time, the properties of the melt, of the extruded molded body and/or of the end product that are measured during operation can be used in particular by regulating the properties by means of the installation control unit 9. Derived properties, such as the operating parameters of downstream assemblies or other installation components, can however also be used, for example by using the motor load of drive assemblies or temperatures.

The operating parameters to be set in the extruder 1, such as pressures, fill level, dwell time and temperature can also be calculated according to the geometric parameters of the specific surface from already known settings of known installations.

The measurement device 8 can also measure the yellow value of the melt online. The installation control unit 9 evaluates these measured values and determines whether an undesirable yellow value, in particular according to DIN 6167, should be established. In this case, the installation control unit 9 triggers a correspondingly necessary addition of solvent.

The installation control unit 9 of the multi-rotation system has a central user interface, which allows access to all the installation components for efficient use of the multiplicity of production-relevant measurement data and set point values. This means that changes in the process can be recognized quickly and corrected if necessary. The production data are stored for later diagnostics and processed by the software as a trend with historization.

The online viscometer 13 makes it possible for polymer properties that have a substantial effect on the product quality to be measured reliably. The measured viscosity is directly related to the molecule chain length, on which mechanical properties such as tensile strength and rigidity depend in turn. These measured data can be collected and stored for quality assurance. By means of a high-precision, constant-output gear pump, a small part-stream of the polymer melt is branched off from the main melt channel and pressed through a very precisely manufactured slit capillary.

Both the melt temperature and the melt pressure measured at two locations are detected by the melt temperature sensors 14 and melt pressure transducers 15. On the basis of these measured values, the online viscometer 13 calculates a value for the representative shear speed and the corresponding representative viscosity. The setting of the process parameters, the evaluation and display are integrated in the installation control unit 9. For instance, the installation control unit 9 inter alia regulates the vacuum via the vacuum system 12 in order to set the desired, required melt viscosity. However, the load received by stretching mechanisms for elongating film webs in the longitudinal direction thereof can also be used to control the melt viscosity by the installation control unit 9. Furthermore, temperature management monitored specifically by the installation control unit 9 is possible, since the temperature of all the faces in contact with the melt can easily be controlled by the heater 11.

With the extruder 1 of the extrusion system according to the invention with the multi-rotation system, high-quality PET packaging films or strips that are suitable for food use can be produced from 100% recycling material, for example highly contaminated recycling PET (polyethylene terephthalate), e.g. PET bottle flakes, with single-stage melt filtration, without any pretreatment (such as cost-intensive and complex pre-drying and crystallization of the PET flakes), by means of the specific degassing zone of the extruder of the multi-rotation system. If multi-stage filtration by means of multi-rotation systems is used instead of single-stage filtration, the degree of purity can be increased further.

The degassing of the extruder 1 of the extrusion system according to the invention by means of the vacuum system 12 serves not only to remove water, but also to decontaminate the output material, e.g. for FDA-approved food use.

In the extruder 1 of the extrusion system, a reactive extrusion, a process for producing or modifying polymers, can also be carried out, in which chemical reactions take place in the extruder 1.

This polymerization (a conversion of low-molecular compounds, for example monomers or oligomers, into high-molecular compounds, e.g. polymers, macromolecules or polymerisates) or more precisely chain polymerization (reactions to build high-molecular compounds according to a chain growth mechanism) and polycondensation (a condensation reaction that takes place in stages and converts monomers into polymers (plastics), different monomers generally being reacted with each other), can proceed in the extruder 1 by setting the operating parameters of the extrusion system accordingly.

The extruder 1 with the multi-screw extruder part 5 processes undried, untreated ground polyester bottle material directly into granules. The surface of the melt is exchanged and broken up very intensively in the multi-screw extruder part 5 in the interior of the extruder 1, so that even with a slight vacuum of for example 25 to 40 mbar a substantial decontamination with Food and Drug Administration (FDA) approval takes place, with only a slight, controlled reduction in viscosity. The conservative processing of the material means that the end product has a high quality, in particular in respect of its yellow value according to DIN 6167 and its transparency.

In the textile industry, non-pre-dried PET bottle flakes or production wastes having very different viscosities can also be processed to form high-quality fibers by means of the extruder 1 with the multi-screw extruder part 5. Staple fibers such as hollow fibers and bi-component fibers can be produced; with the latter it is possible to produce different viscosities from one input material by applying different vacuums at two extruders 1. Furthermore, the extruder 1 can be used in the processing of bottle flakes or production wastes to produce carpet fibers and nonwovens as bi-components. The use of 100% ground bottle material considerably saves on input material costs. The installations can be combined with all current downstream extrusion dies 2 to produce fibers.

To recycle industrial wastes, either shredders or cutting mills, depending on the quality of the raw materials used, are used for comminution, so that the output material provided to the material supply 3 can be metered. This very lightweight material is then either fed directly to the extruder 1 by means of feed assemblies such as plugging screws or else compacted by a further process step, for example pelleting, and then fed to the extruder 1.

Even fibre wastes having large amounts of oils and other contaminants and a high moisture content can be fed directly to the extruder 1 without pretreatment. In the extruder 1, the material is melted, degassed and decontaminated. Volatile foreign materials such as water or spinning oils can be removed simply in the extruder 1, producing an environmentally friendly and economical extrusion system with a multi-rotation system.

With the extruder 1 of the extrusion system according to the invention, PET strips of high tensile strength can be produced with 100% recycled material, owing to the homogeneous melts produced. Despite the omission of the time- and energy-intensive stages of pre-drying and crystallizing the PET flakes, similar qualities in respect of tear strength, elasticity and splicing behavior to conventional single-screw and double-screw methods are achieved. In addition, the highly efficient degassing makes possible a high melt purity with much lower monomer and oligomer fractions than with conventional methods, so the risk of strip breakage and predefined breaking points during production is reduced.

The production process can be made particularly efficient if the extruder is not charged with solid raw material but (at least partially) directly with polymer from a polymerization installation or another extrusion system, since as a result e.g. the thermal energy already present in the material can be used better thereby, by for example saving on repeated melting, and/or the time between the stages is reduced (e.g. chemical decomposition of compounds, chemical reactions in the polymer) and/or the process can be made particularly cost-effective and efficient by a continuous operating method.

The configuration according to the invention of the multi-rotation system thus produces an extrusion system for producing molded parts from plastics, consisting of at least one material supply for solid, liquid and/or gaseous raw materials or additives, at least one process part of the multi-rotation system and one or more downstream extrusion dies and further assemblies arranged in a technically meaningful manner, such as plasticizing extruders (single- or multi-shaft system), melt extruders (single- or multi-shaft system), melt pumps, static and dynamic mixers, mixing blocks, melt filters, screen changers, melt valves, melt coolers, secondary extruders, gas injectors, liquid metering systems, continuously operating reactors, cutter compactors and/or agglomerators.

Furthermore, any other process in which otherwise single- or multi-shaft extruders are used can be operated in the multi-rotation system in the module with extruder screws (input and/or output). The operating parameters to be set in the process part, such as pressures, fill level, dwell time and temperature can be calculated according to the geometric parameters of the specific surface from already known settings of known installations. It is generally the case here that a higher diffusion rate is achieved (and therefore the product properties are influenced more or more efficiently) with the same concentration gradient between melt and gas space or, conversely, a lower concentration gradient can be used to achieve the same product or melt properties.

The extruder can be used in any known process in which a plasticiser and/or conveyor screw is used. The mixing action of the extruder in the MRS generally has a positive effect on the material properties. Added to this is the possibility of removing gas from or supplying gas to the processed polymer or polymer mixture by means of the extruder. This can be used to improve the material properties of the end product, e.g. by removing disruptive volatile constituents or reactive contents during degassing and by correspondingly adding useful constituents or reactive components when gas is supplied.

Since this process proceeds much more efficiently in comparison with conventional extrusion and conveyor systems, there is the possibility, depending on the desired material property of the end product, to save on other process steps in the processing chain, e.g. to omit pre-drying and crystallization, or else to modify the process management thereof in such a manner that they work in a much more cost-effective manner.

Whenever there is a monotonically rising/falling profile of the quantified material property, e.g. tensile strength of the end product, melt viscosity, yellow value, molecule chain length, additive content, contaminant content, density etc. with the pressure in the MRS part, or of the partial pressure of a specific substance, the property can accordingly be influenced simply by increasing or decreasing the pressure in the MRS part.

Such monotonic relationships are, for example: Processing PET: Increasing molecular weight, IV value, melt viscosity, tensile strength of the end product etc. by decreasing the partial pressure of water;
Decreasing the concentration of any volatile substance in the end product—decreasing the partial pressure, removing monomers, decontamination of volatile substances;
Decreasing the density of a foamed product—increasing the partial pressure of the blowing agent in the MRS.

For instance, in the processing of polyester, to achieve a predefined product quality—in this case melt viscosity—by means of the efficient possibility of removing water, the residual moisture to be set can be selected to be higher in the pre-processing step of crystallization and drying, which for the pre-drying corresponds to a reduction in the process temperature and/or a reduction in the process time and/or an increase in the dew point. In borderline cases, the pre-processing step pre-drying can be omitted altogether.

To determine the necessary partial pressure of water in the process part of the MRS, the parameters of the pre-treatment are pre-selected and the material properties of the processed melt or of the end product are used to determine the necessary partial pressure of the water in the MRS.

Proceeding from this process point, the product quality—in this case melt viscosity—can then be increased by further reducing the pressure.

The extruder can also be used to recycle foamed plastics, in particular foam products consisting of PE, PP, PS and PET. The efficient degassing allows the foamed plastics to be compacted cost-effectively.

The mixing action of the extruder can also be used to produce a homogeneous melt from very different polymers. The processing of ground film materials consisting of multi-layered films or laminated films, e.g. PET+PE or PET+PETG, has proven particularly effective in this case. These ground film materials cannot be dried with conventional drying methods, since the drying temperature of one component is above the softening temperature of the other component. Since undried raw materials can also be processed with the extruder owing to the efficient degassing, a particularly significant simplification of the processing method results in this case.

LIST OF REFERENCE SYMBOLS

| | |
|---|---|
| 1 | Extruder |
| 2 | Downstream extrusion die |
| 3 | Material supply |
| 4 | Extruder input part |
| 5 | Multi-screw extruder part |
| 6 | Extruder output part |
| 7 | Melt filter |
| 8 | Measurement device |
| 9 | Installation control unit |
| 10 | Motor |
| 11 | Heater |
| 12 | Vacuum system |
| 13 | Online viscometer |
| 14 | Melt temperature sensors |
| 15 | Melt pressure transducers |

We claim:

1. An extrusion system for producing molded parts from plastics, comprising:
an extruder (1) for obtaining plastic melts, which has an extruder input part (4) for receiving, melting and working plastic material, a multi-screw extruder part (5), which is connected to the extruder input part (4), and an extruder output part (6) for outputting the melt;
a material supply (3), which is assigned to the extruder input part (4), for solid, liquid and/or gaseous raw materials or additives;
a motor (10) for driving the extruder (1) in a rotary manner;
a heater (11);
a vacuum system (12), which is assigned at least to the multi-screw extruder (5),
a measurement device (8) and a downstream extrusion die (2) on the extruder output part (6), and
an installation control unit (9) for receiving measurement signals of the measurement device (8) and controlling the individual components of the extrusion system (1 to 15) and configured such that dose and/or fill level and/or dwell time and/or extruder rotation speed and/or vacuum can be regulated and set by means of the material supply (3) and/or the motor (10) and/or the vacuum system (12) in such a manner that the respective molded parts to be created have optimal properties in respect of the demands made of them.

2. The extrusion system according to claim 1, wherein the measurement device (8) has an online viscometer (13) for online measurement of the melt viscosity.

3. The extrusion system according to claim 1, wherein the measurement device (8) has melt pressure transducers (15) for controlling the vacuum in the extruder (1) by means of the installation control unit (9), in order to set the melt viscosity.

4. The extrusion system according to claim 1, wherein the installation control unit (9) is configured such that property measured values derived from the downstream extrusion dies (2) are determined in order to control the individual components of the extrusion system (1 to 15).

5. The extrusion system according to claim 4, wherein the installation control unit (9) is supplied with the operating parameters of the downstream extrusion dies (2) as measured values for controlling the individual components of the extrusion system (1 to 15).

6. The extrusion system according to claim 4, wherein the installation control unit (9) is supplied with the load received by stretching mechanisms for elongating film webs in the longitudinal direction thereof for controlling the melt viscosity and/or the motor load of drive assemblies as operating parameters of the downstream extrusion dies (2).

7. The extrusion system according to claim 1, wherein the measurement device (8) is configured such that the yellow value of the melt is detected online and any addition of solvent necessary is controlled by means of the installation control unit (9).

8. The extrusion system according to claim 1, wherein the vacuum system (12), which is assigned to the extruder (1) in order to remove gases or substances from the melt, applies a required pressure to the melt, controlled by the installation control unit (9) on the basis of the measured values of the measurement device (8).

9. The extrusion system according to claim 1, wherein the installation control unit (9) is configured such that it calculates the parameters to be set at the extruder (1), such as pressures, fill level, dwell time and temperature, according to the geometric parameters of the specific surface from already known settings of known installations.

10. The extrusion system according to claim 1, wherein the installation control unit (9) is configured such that in particular the properties of the melt, of the extruded molded body and/or of the end product that are measured during operation are regulated by controlling the vacuum.

11. The extrusion system according to claim 1, wherein the extruder input part (4) and/or the extruder output part (6) have a central screw or a double screw.

12. The extrusion system according to claim 1, wherein the multi-screw extruder part (5) has interior satellite screws, which are set in rotation in the opposite direction to the rotation of the central screws by a gearing mechanism.

13. The extrusion system according to claim 1, wherein the extruder (1) can be charged with polymer from a polymerization installation or other extrusion system.

14. The extrusion system according to claim 1, wherein the molded parts consist of polymer or polymer mixtures, to which further constituents, additives or fillers can be added to produce the desired product properties.

15. The extrusion system according to claim 1, wherein further assemblies, such as plasticizing extruders, melt extruders, melt pumps, static and/or dynamic mixers, mixing blocks, screen changers, melt valves, melt coolers, secondary extruders, gas injectors, liquid metering systems, continuously operating reactors, cutter compactors and/or agglomerators, are assigned to the extruder (1).

16. The extrusion system according to claim 1, wherein a melt filter (7) is arranged on the extruder output part (6).

17. The extrusion system according to claim 1, wherein the plastic blanks are plastic granules, PET bottle flakes or fibrous materials.

18. The extrusion system according to claim 1, wherein the downstream extrusion die (2) creates molded parts from the group of yarns such as filaments, staple fibers, POY (partially oriented yarn) fibers or filaments, FDY (fully drawn yarn) fibers or filaments, fibers and/or BCF (bulked continuous filament).

19. The extrusion system according to claim 1, wherein the downstream extrusion die (2) creates molded parts such as boards, axially or biaxially drawn films, strips and/or ribbons.

20. The extrusion system according to claim 1, wherein the downstream extrusion die (2) creates molded parts such as granules, tubes, profiles, meshes, spunbonds, melt-blown nonwovens and/or injection-molded bodies.
